(19) United States
(12) Patent Application Publication
(10) Pub. No.: US 2013/0151193 A1
(43) Pub. Date: Jun. 13, 2013

(54) METHOD AND APPARATUS FOR DETERMINING MOTION EXPLOSIVENESS

(71) Applicants: Christopher J. Kulach, Calgary (CA); Eugene So, Calgary (CA); Paul R. MacDonald, Calgary (CA); James K. Rooney, Cochrane (CA)

(72) Inventors: Christopher J. Kulach, Calgary (CA); Eugene So, Calgary (CA); Paul R. MacDonald, Calgary (CA); James K. Rooney, Cochrane (CA)

(73) Assignee: GARMIN SWITZERLAND GMBH, Schaffhausen (CH)

(21) Appl. No.: 13/526,151

(22) Filed: Jun. 18, 2012

Related U.S. Application Data
(60) Provisional application No. 61/499,574, filed on Jun. 21, 2011.

(51) Int. Cl. G01P 15/02

(52) U.S. Cl. CPC G01P 15/02
USPC 702/141

(57) ABSTRACT

A method and apparatus for determining motion explosiveness is described herein. In some configurations, a system is provided that includes a display, an inertial sensor operable to generate signals corresponding to user motion; and a processing system in communication with the inertial sensor and the display. The processing system is operable to calculate a histogram representing the sensed user motion, the histogram providing an indication of motion explosiveness, and communicate with the display to present the indication of motion explosiveness on the display.

### RELATED APPLICATIONS

The present application claims the priority benefit of co-pending U.S. Provisional Application No. 61/499,574, filed Jun. 21, 2011 and entitled “METHOD AND APPARATUS FOR DETERMINING MOTION EXPLOSIVENESS.” The above-identified application is incorporated herein by specific reference in its entirety.

### BACKGROUND

An individual athlete's performance can be crucial to the outcome of a sporting event in both individual and team sports. Athletic performance can be analyzed in a number of ways. For example, performance can be defined by the sport and/or the position of the athlete. Different measurement techniques can be utilized depending upon the performance trait to be measured.

### BRIEF DESCRIPTION OF THE DRAWING FIGURES

Various embodiments of the present invention are described in detail below with reference to the attached drawing figures, wherein:

FIG. 1 is a schematic diagram illustrating a user employing a sensor unit and a user interface unit configured in accordance with various embodiments of the present invention;

FIG. 2 is a schematic diagram illustrating an exemplary orientation of various sensors within or on a shoe;

FIG. 3 is a block diagram illustrating some of the components operable to be utilized by various embodiments of the present invention;

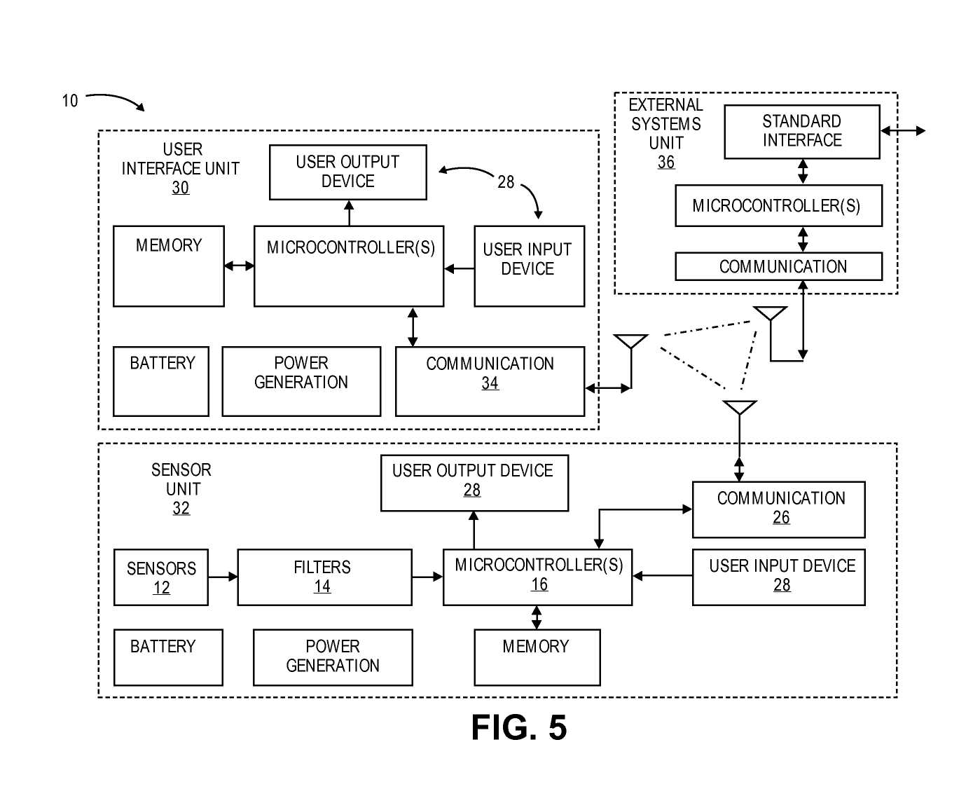

FIG. 4 is a block diagram illustrating some of the components of FIG. 3 in more detail;

FIG. 5 is a block diagram illustrating an external systems unit in communication with the sensor unit and user interface unit of FIG. 1;

FIG. 6 is a block diagram illustrating the user interface unit and sensor unit of FIG. 5 in communication with a GPS receiver;

FIG. 7 is a block diagram illustrating another configuration of the user interface unit and GPS receiver of FIG. 5;

FIG. 8 is a block diagram illustrating another configuration of the sensor unit and GPS receiver of FIG. 5;

FIG. 9 is a block diagram illustrating another configuration of the GPS receiver, user interface unit, and sensor unit of FIG. 5;

FIG. 10 is a schematic diagram showing the interaction of a plurality of apparatuses configured in accordance with various embodiments of the present invention;

FIG. 11 is an example histogram illustration the partial statistical distribution of acceleration during a soccer game;

FIG. 12 is a cumulative distribution of the information presented in FIG. 11;

FIG. 13 is an example illustration showing a comparison of multi-stride acceleration for a user during a soccer game;

FIG. 14 is another exemplary acceleration distribution;

FIGS. 15 through FIGS. 19 are exemplary heart rate histograms; and

FIG. 20 is an exemplary speed histogram.

The drawing figures do not limit the present invention to the specific embodiments disclosed and described herein. The drawings are not necessarily to scale, emphasis instead being placed upon clearly illustrating various embodiments of the invention.

### DETAILED DESCRIPTION

The following detailed description of various embodiments of the invention references the accompanying drawings which illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

Various embodiments of the present invention provide a motion sensing apparatus 10 operable to generate a motion model using parameters estimated from a plurality of sources, such as inertial sensors and navigation devices. The motion model may be used to estimate a parameter corresponding to one of the sources if the source is unavailable. Such a configuration allows the estimation of motion parameters corresponding to a parameter type (e.g., user speed) if the apparatus 10 is unable to receive signals from an external source.

In various embodiments, the apparatus 10 can include one or more accelerometers 12, a filtering element 14, and a processing system 16. The accelerometers 12, filtering element 14, and processing system 16 may be integrated together or form discrete elements that may be associated with each other. The processing system 16 is generally operable to analyze measurements provided by the one or more accelerometers 12 to estimate parameters corresponding to one or more parameter types.

The one or more accelerometers 12 are each operable to measure an acceleration and generate an acceleration measurement corresponding to the measured acceleration. The acceleration measurement may be embodied as a signal operable to be utilized by the filtering element 14 and/or processing system 16. In some embodiments, one or more of the accelerometers 12 may be operable to output an analog signal corresponding to an acceleration measurement. For instance, each accelerometer 12 may output an analog voltage signal that is proportional to measured accelerations. In some embodiments, one or more of the accelerometers 12 may include the ADXL321 accelerometer manufactured by ANALOG DEVICES of Norwood, Mass. However, the one or more accelerometers 12 may include any digital and analog components operable to generate a signal corresponding to a measured acceleration. Thus, in some embodiments, one or more of the accelerometers 12 are operable to output a digital signal representing measured accelerations. Further, in some embodiments, one or more of the accelerometers 12 may comprise linear accelerometers.

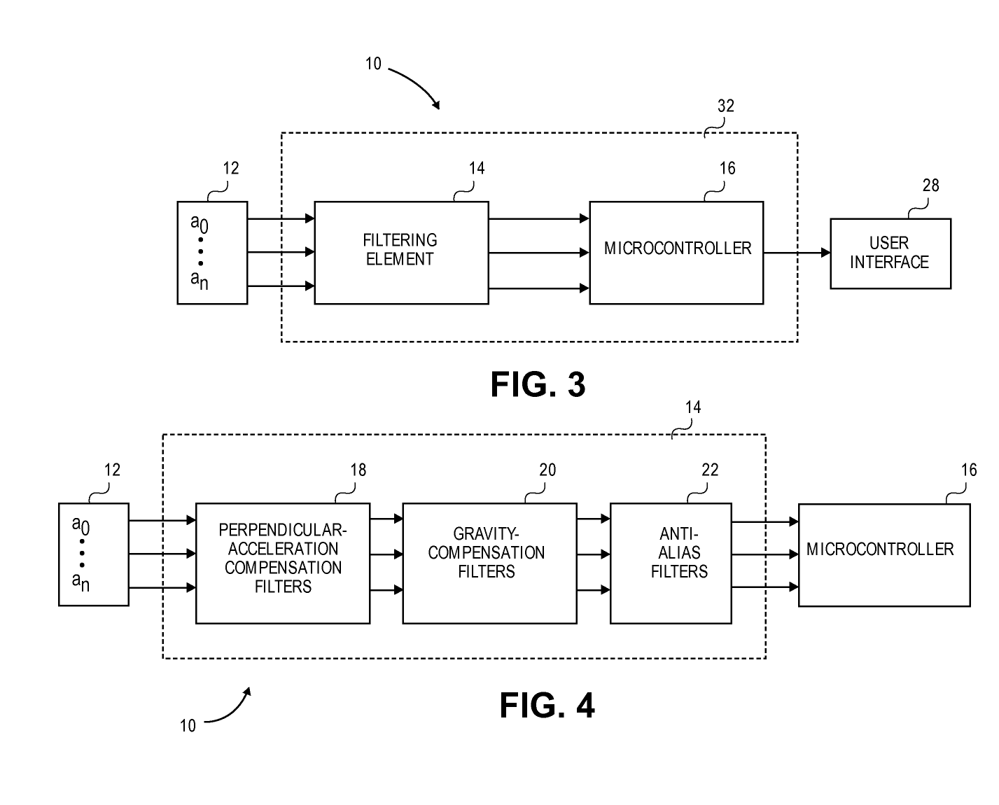

In some embodiments, more than one of the accelerometers 12 may be integrated into the same integrated circuit package to allow the single package to provide acceleration measurements along more than one axis. For example, as shown in FIG. 2, the apparatus 10 may include two or more accelerometers 12 each operable to output a signal corresponding to a measured acceleration. In some embodiments, the apparatus 10 includes at least two accelerometers 12 adapted to measure accelerations in two directions separated by an angle greater than zero degrees and each provide a signal corresponding to the measured acceleration. Further, the apparatus 10 may include at least three accelerometers 12 adapted to measure accelerations in three directions each separated by an angle greater than zero degrees and each provide a signal corresponding to the measured acceleration. In some embodiments, the three accelerometers 12 may be oriented in a mutually perpendicular configuration. However, the apparatus 10 may include any number of accelerometers 12, including a single accelerometer 12, positioned in any configuration to provide acceleration measurements for use by the filtering element 14 and/or processing system 16.

The one or more of the accelerometers 12 may be operable to communicate with other elements of the apparatus 10, or elements external to the apparatus 10, through wired or wireless connections. Thus, the accelerometers 12 may be coupled with the filtering element 14 and/or processing system 16 through wires or the like. One or more of the accelerometers 12 may also be configured to wirelessly transmit data to other apparatus 10 elements and devices external to the apparatus 10. For instance, one or more of the accelerometers 12 may be configured for wireless communication using various RF protocols such as Bluetooth, Zigbee, ANT®, and/or any other wireless protocols.

The filtering element 14 is operable to couple with the one or more accelerometers 12 and filter acceleration measurements and/or signals corresponding to acceleration measurements. In some embodiments, the apparatus 10 does not include the filtering element 14 and the processing system 16 is operable to use unfiltered acceleration measurements and corresponding signals. In other embodiments, the filtering element 14 may be integral with one or more of the accelerometers 12, the processing system 16, or both the accelerometers 12 and the processing system 16. For example, a first portion of the filtering element 14 may be integral with one or more of the accelerometers 12 and a second portion of the filtering element 14 may be integral with the processing system 16. In other embodiments, the filtering element 14 may be discrete from both the accelerometers 12 and the processing system 16.

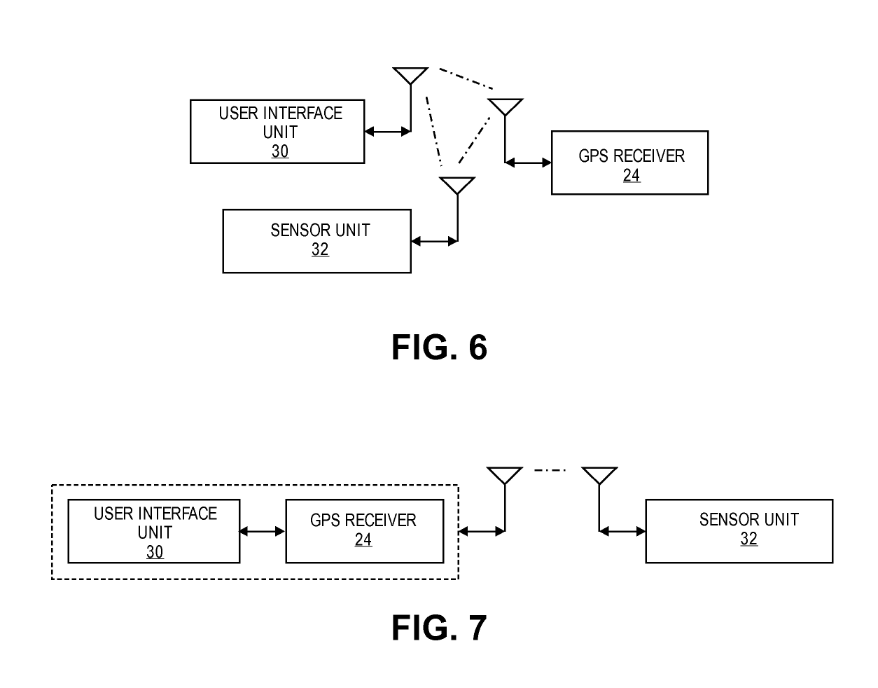

The filtering element 14 may include analog and digital components operable to filter and/or provide other pre-processing functionality to facilitate the estimation of motion parameters by the processing system 16. In various embodiments as shown in FIG. 4, the filtering element 14 is operable to filter signals provided by the one or more accelerometers 12, or signals derived therefrom, to attenuate perpendicular acceleration, to compensate for gravity, and/or to minimize aliasing. The filtering element 14 may include discrete components for performing each of these filtering functions or use the same components and hardware for these, and other, filtering functions.

The filtering element 14 may include any analog and digital components for filtering signals and measurements, including passive and active electronic components, processors, controllers, programmable logic devices, digital signal processing elements, combinations thereof, and the like. In some embodiments, the filtering element 14 may include a digital microcontroller, such as the MSP430F149 microcontroller manufactured by TEXAS INSTRUMENTS to provide various static and/or adaptive filters. The filtering element 14 may also include an analog-to-digital converter to convert analog signals provided by the one or more accelerometers 12 to digitize signals for use by the processing system 16. The filtering element 14 may also include conventional pre-sampling filters.

In some embodiments, the low-pass filter 18 may be an adaptive filter operable to employ static and/or varying cut-off frequencies between about 0.5 Hz and 10 Hz. In some embodiments where parameters corresponding to human strides are estimated, the low-pass filter 18 may employ cut-off frequencies between about 1 Hz and 3 Hz. The filtering element 14 may acquire the cut-off frequency from the processing system 16 based on computations performed by the processing system 16 corresponding to the particular stride frequency of the subject element S. The low-pass filter 18 may additionally or alternatively be adapted to employ a cut-off frequency corresponding to a gait type identified by the processing system 16.

In other embodiments, the cut-off frequency for the low-pass filter 18 may be a static value based upon the typical stride frequency of a running or walking human. For instance, the cut-off frequency may correspond to a frequency between one and two times the typical stride frequency of a running and/or walking human, such as a static frequency between 1 Hz and 3 Hz. Specifically, in some embodiments, the cut-off frequency may be about 1.4 5Hz for walking humans and about 2.1 Hz for jogging humans.

The gravity compensation provided by the filtering element 14 generally compensates for the constant acceleration provided by gravity that may be sensed by one or more of the accelerometers 12. In some embodiments, the filtering element 14 includes a high-pass filter 20 operable to filter or attenuate components of signals corresponding to measured accelerations below a given cut-off frequency. The cut-off frequency of the high-pass filter 20 may correspond to a frequency approaching 0 Hz, such as 0.1 Hz, to adequately provide compensation for gravity-related acceleration.

The anti-aliasing provided by the filtering element 14 generally reduces or prevents aliasing caused by sampling of the signals provided by, or derived from, the one or more accelerometers 12. In some embodiments, the filtering element 14 includes a relatively wideband filter 22 designed to attenuate signal frequencies in excess of one-half of the sampling frequency used in any subsequent analog-to-digital conversions provided by the processing system 16 or other devices associated with the apparatus 10. In some embodiments, the filtering element 14 may provide other filtering components instead of, or in addition to, the wideband filter 22 to compensate for aliasing. For instance, the filtering element 14 may include one or more analog and/or digital filters to perform any combination of the various filtering functionality discussed herein. In some embodiments, a single filtering element may be utilized to perform each of the filtering functions discussed above such that separate or discrete filters are not necessarily employed for different filtering functions.

The processing system 16 is generally operable to couple with the one or more accelerometers 12 and/or the filtering element 14 to estimate a motion parameter corresponding to a motion parameter type. The processing system 16 may include various analog and digital components operable to perform the various functions discussed herein. In some embodiments, the processing system 16 may include a microprocessor, a microcontroller, a programmable logic device, digital and analog logic devices, computing elements such as personal computers, servers, portable computing devices, combinations thereof, and the like.

The processing system 16, filtering element 14, accelerometers 12, and/or other portions of the apparatus 10 may limit or expand the dynamic range of acceleration measurements used to generate the motion parameter metric and/or identify attachment position. For example, acceleration measurements outside a specified dynamic range, such as plus or minus 8g, may be saturated at the dynamic range limits to further limit the effects of perpendicular acceleration. Alternatively, linear or non-linear amplifiers may be used to increase or reduce the dynamic range. The dynamic range may be varied by the processing system 16 based on the particular motion parameter being estimated or according to other sensed or generated measurements.

The processing system 16 may also include, or be operable to couple with, a memory. The memory may include any computer-readable memory or combination of computer-readable memories operable to store data for use by the processing system 16. For instance, the memory may be operable to store acceleration data, motion parameter metric data, statistical data, motion parameter data, filtering data, configuration data, combinations thereof, and the like.

The processing system 16 may be discrete from the various accelerometers 12 and filtering element 14 discussed above. In other embodiments, the processing system 16 may be integral with other portions of the apparatus 10. For instance, the same microcontroller or microprocessor may be utilized to implement the filtering element 14 and the processing system 16.

In some embodiments, data and information generated by the accelerometers 12, filtering element 14, and/or processing system 16 may be stored in the memory associated with the processing system 16, or in any other computer-readable memory, to allow later analysis by the processing system 16 or other devices associated therewith. The stored information may be time-correlated to facilitate analysis and compressed to reduce the required capacity of the memory.

The processing system 16 may additionally or alternatively utilize information acquired from sensors other than the one or more accelerometers 12. For instance, in some embodiments the processing system 16 may couple with a heart rate monitor 38, acquire heart rate information from the heart rate monitor 38, and generate a motion parameter using the heart rate information and/or acceleration measurements. Similarly, the processing system 16 may couple with other sensors to acquire non-acceleration kinematic variables such as velocity and/or environmental variables such as ambient temperature and altitude. For example, to acquire additional information, the processing system 16 may couple with, and/or include, radio-frequency transceivers, thermometers, altimeters, compasses, inclinometers, pressure sensors, blood pressure monitors, light sensors, atmospheric sensors, angular velocity sensors and other inertial sensors, microphones, computing devices such as personal computers, cellular phones, and personal digital assistances, other similarly configured apparatuses, combinations thereof, and the like.

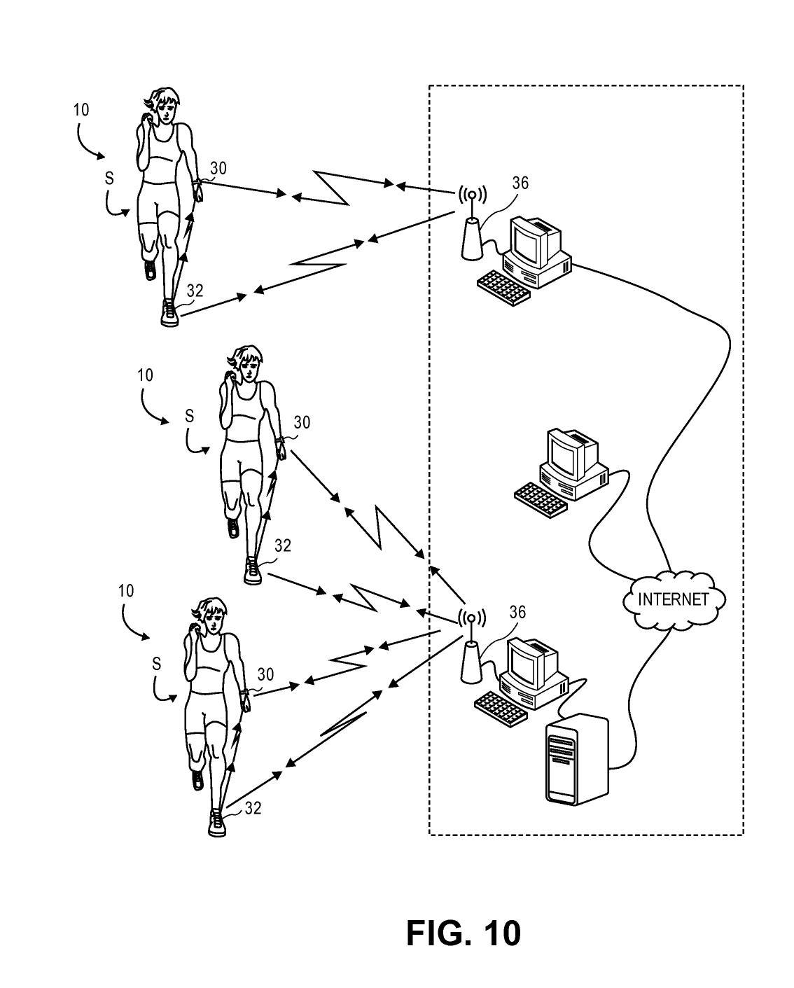

In some embodiments, as shown in FIGS. 6 through 9, the apparatus 10 may be operable to receive information from at least one navigation device 24. The navigation device 24 may be adapted to provide geographic location information to the apparatus 10 and users of the apparatus 10. The navigation device 24 may include a GPS receiver much like those disclosed in U.S. Pat. No. 6,434,485, which is incorporated herein by specific reference. However, the navigation device 24 may use cellular or other positioning signals instead of, or in addition to, the GPS to facilitate determination of geographic locations. The navigation device 24 may be operable to generate navigation information such as the speed of the navigation device 24, the current and previous locations of the navigation device 24, the bearing and heading of the navigation device 24, the altitude of the navigation device 24, combinations thereof, and the like.

The processing system 16 may use the information received from the navigation device 24 to estimate a motion parameter and/or generate a motion model. The processing system 16 may also use and present acquired navigation information independent of the metrics and estimated parameters. Additionally or alternatively, the processing system 16 may use the information acquired from the navigation device 24 to correct and/or adjust calculated information. For instance, the processing system 16 may compare distances and speeds generated from accelerations provided by the one or more accelerometers 12 with distances and speeds provided by the navigation device 24 and correct calculated measurements to enable distances and speeds generated from measured accelerations to be as accurate as those provided by the navigation device 24. Thus, the processing system 16 may be periodically coupled with the navigation device 24 to correct information to ensure that the apparatus 10 accurately estimates motion parameters even when not coupled with the navigation device 24. Such functionality is discussed in more detail below.

The filtering element 14 and processing system 16 may additionally be operable to compensate for part-to-part manufacturing variability present in the one or more accelerometers 12, including characterization over temperature of zero-g bias point, sensitivity, cross-axis sensitivity, nonlinearity, output impedance, combinations thereof, and the like.

In some embodiments, compensation parameters are periodically adjusted during device use. For example, if the processing system 16 detects that the apparatus 10 is substantially stationary, the sum of accelerations provided by the one or more accelerometers 12 may be compared to an expected acceleration sum of 1 g (g is the gravitational constant, 9.81 m/s²), and the difference may be used by the processing system 16 to adjust any one of or a combination of compensation parameters.

Thus, for example, if xₘ, yₘ, zₘ are acceleration measurements produced by three accelerometers 12 oriented in substantially mutually perpendicular directions and the accelerometers are at rest, the combined measured acceleration can be expected to be xₘ²+yₘ²+zₘ²=g². If it is assumed that xₘ and yₘ are accurate, then in xₘ²+yₘ²+z_{c}²=g² the only unknown is z_{c}, and the processing system 16 can compute z_{c} from xₘ and yₘ whenever the unit is mostly stationary, and compare this value to measured zₘ. The difference between the measured acceleration zₘ and the computed acceleration z_{c} can be assumed to be attributable to inadequate compensation of the z measurement for part-to-part manufacturing variability, temperature sensitivity, humidity sensitivity, etc. Consequently, an adjustment to one or more of the compensation parameters can be made based on the difference. By periodically adjusting compensation parameters based on stationary gravitational assumptions, it may thus be possible to eliminate or reduce the complexity of compensation parameter modeling in some embodiments. However, embodiments of the present invention may employ or not employ any combination of compensation methods and parameters.

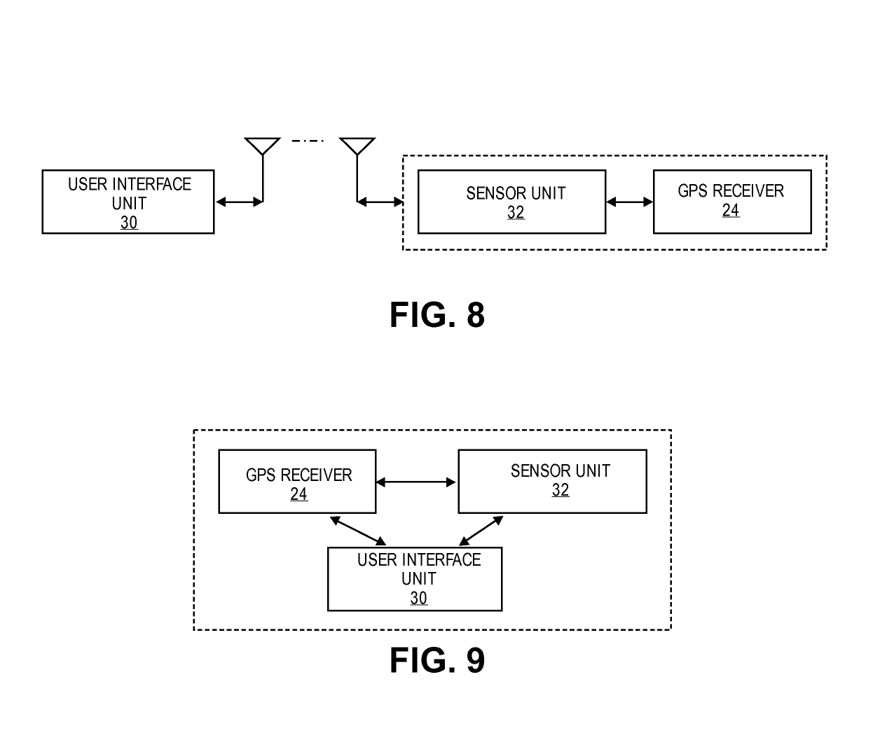

In some embodiments, as shown in FIG. 5, the apparatus 10 may include a communications element 26 to enable the apparatus 10 to communicate with other computing devices, exercise devices, navigation devices, sensors, and any other enabled devices through a communication network, such as the Internet, a local area network, a wide area network, an ad hoc or peer to peer network, combinations thereof, and the like. Similarly, the communications element 26 may be configured to allow direct communication between similarly configured apparatuses using USB, ANT®, Bluetooth, Zigbee, Firewire, and other connections, such that the apparatus 10 need not necessarily utilize a communications network to acquire and exchange information.

In various embodiments the communications element 26 may enable the apparatus 10 to wirelessly communicate with communications networks utilizing wireless data transfer methods such as WiFi (802.11), Wi-Max, Bluetooth, ultra-wideband, infrared, cellular telephony (GSM, CDMA, etc.), radio frequency, and the like. However, the communications element 26 may couple with the communications network utilizing wired connections, such as an Ethernet cable, and is not limited to wireless methods.

The communications element 26 may be configured to enable the apparatus 10 to exchange data with external computing devices to facilitate the generation and/or analysis of information. For example, the processing system 16 may use information acquired through the communications element 26 in estimating motion parameters and/or in generating motion models. The processing system 16 may also provide generated motion parameter metrics, motion models, and estimated motion parameters through the communications element 26 for use by external devices. For instance, the external devices can be configured to store, analyze, and exchange information between a plurality of users and/or a plurality of devices attached to one or multiple users.

Consequently, the communications element 26 generally enables real-time comparison of information generated by the apparatus 10 and other devices. The communications element 26 also enables the apparatus 10 to store data on one or more of the external devices for later retrieval, analysis, aggregation, and the like. The data can be used by individuals, their trainers or others to capture history, evaluate performance, modify training programs, compare against other individuals, and the like. The data can also be used in aggregated form.

The apparatus 10 may additionally include a user interface 28 to enable users to access various information generated and acquired by the apparatus 10, such as attachment positions, acceleration measurements, motion parameter metrics, estimated motion parameters, generated motion models, navigation information acquired from the navigation device 24, information and data acquired through the communications element 26, configuration information, combinations thereof, and the like. The user interface 28 facilities, for example, powering on/off the apparatus 10, selecting which content to display, and providing configuration information such as the attributes of the subject element S.

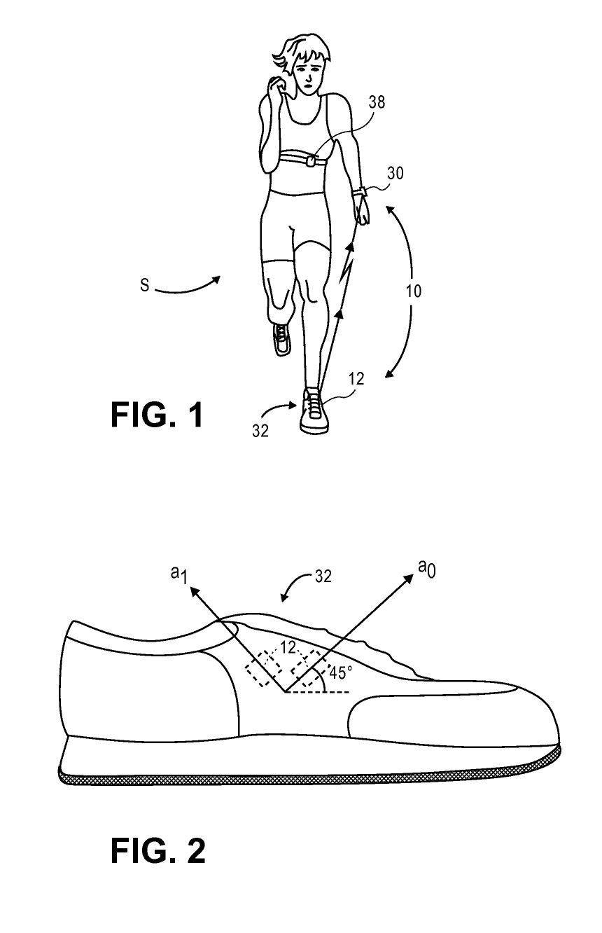

The user interface 28 may include one or more displays to visually present information for consumption by users and one or more speakers to audibly present information to users. The user interface 28 may also include mechanical elements, such as buzzers and vibrators, to notify users of events through mechanical agitation. In some embodiments, as shown in FIG. 1, the user interface 28 may be implemented within a watch operable to be worn on a user's wrist, forearm, and/or arm. Thus, the user interface 28 may be positioned separately from one or more of the accelerometers 12 to enable the user to easily interact with the apparatus 10. However, in some embodiments the user interface 28 and accelerometers 12 may be integral.

The user interface 28 may also be operable to receive inputs from the user to control the functionality of the processing system 16 and/or devices and elements associated therewith. The user interface 28 may include various functionable inputs such as switches and buttons, a touch-screen display, optical sensors, magnetic sensors, thermal sensors, inertial sensors, a microphone and voice-recognition capabilities, combinations thereof, and the like. The user interface 28 may also include various processing and memory devices to facilitate its functionality.

The user interface 28 enables users to receive real-time feedback concerning the estimated motion parameter and associated information. For instance, the user interface 28 may present the currently estimated motion parameter, such as a current stride speed and distance, and/or information associated therewith or with other motion parameters, such as total distance, calories expended, total speed, combinations thereof, and the like.

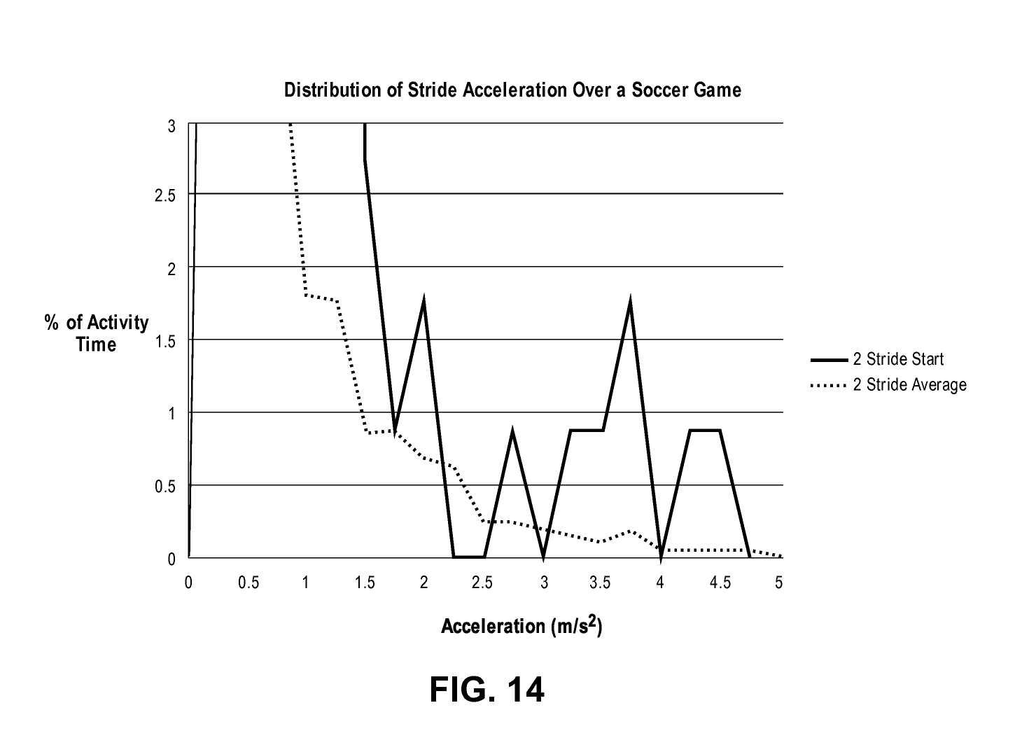

Utilizing the communications element 26, the user interface 28 also enables users to receive real-time feedback and comparisons with other users and devices. For instance, as shown in FIG. 10, a plurality of apparatuses 10 may be employed by a plurality of runners to enable data, metrics, and parameters corresponding to each runner to be shared and presented to the user. Thus, for instance, the user may ascertain the speed and location of other users through the user interface 28.

Further, the user interface 28 may acquire comparison information from the processing system 16 and/or from other devices through the communications element 26 to enable the user to compare his or her performance using the comparison information. For instance, the user interface 28 may present a comparison of the user's current performance with a previous performance by the user, with a training model, and/or with another individual.

In various embodiments, the user may configure the apparatus 10 utilizing the user interface 28 to monitor estimated motion parameters and alert the user through the user interface 28 when one or more estimated motion parameters conflict with a user-defined condition such as an acceptable parameter range, threshold, and/or variance. The user may also configure the apparatus 10 utilizing the user interface 28 to monitor various user-defined goals, such as time limits, motion parameter maximum values, and the like.

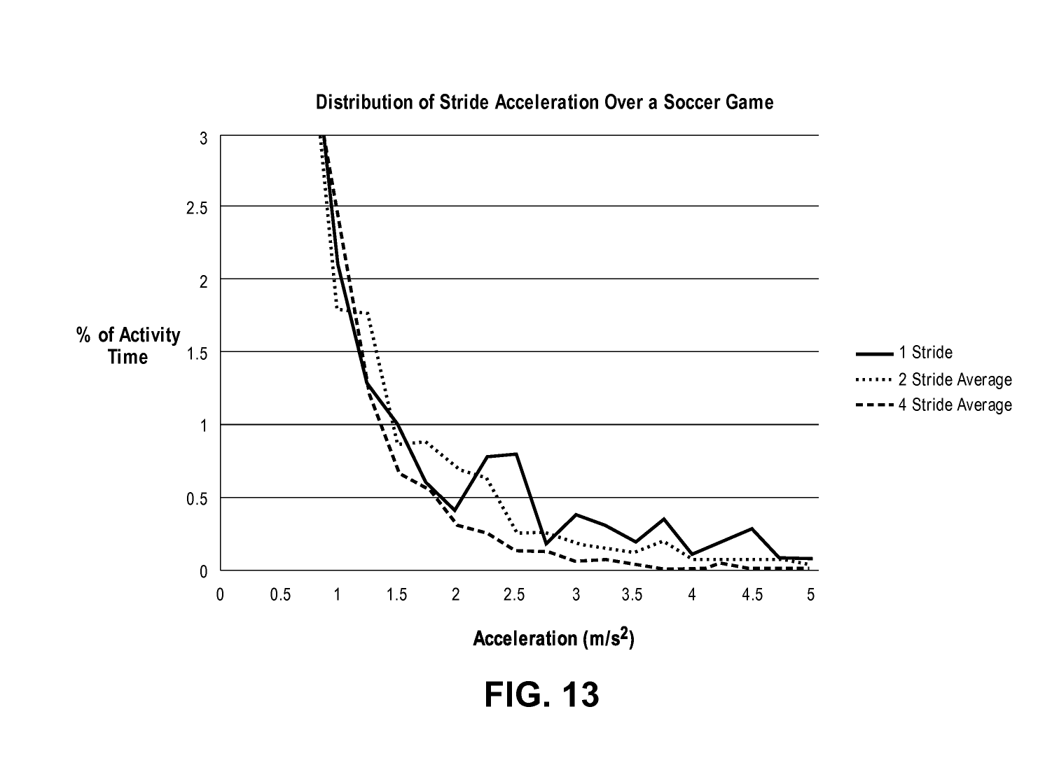

As is discussed above, the various components of the apparatus 10 may be housed integrally or separately in any combination. In some embodiments, the apparatus 10 includes an interface unit 30 for housing the user interface 28 and associated components and a sensor unit 32 for housing the one or more accelerometers 12 and the communications element 26. In such embodiments, the processing system 16 (housed within both or either unit 30, 32) is operable to determine the attachment position of the sensor unit 32. In some embodiments, the units 30, 32 may be housed within the same housing, as is shown in FIG. 9. However, in other embodiments the units 30, 32 may be discrete such that the sensor unit 32 may be positioned in a first location, such as on the user's shoe, and the interface unit 30 may be positioned at a second location, such as on the user's wrist.

The interface unit 30 may also include an interface communication element 34, configured in a similar manner to the communications element 26 discussed above, to enable the interface unit 30 to exchange information with the sensor unit 32, other parts of the apparatus 10, and/or with devices external to the apparatus 10. In embodiments where the units 30, 32 are positioned separate from each other, the communications elements 26, 34 may communicate utilizing the various wireless methods discussed above. However, the communications elements 26, 34 may also communicate utilizing wired connections or through external devices and systems.

The units 30, 32 may also each include power sources for powering the various components of the apparatus 10, such as through the use of batteries or power-generating elements such as piezoelectric, electromechanical, thermoelectric, and photoelectric elements. In some embodiments, portions of the user interface 28 may be included with both units 30, 32 such that each unit 30, 32 and its respective components can be individually functioned by the user.

As shown in FIG. 5, the apparatus 10 may additionally include an external systems unit 36 to enable the interface unit 30 and sensor unit 32 to easily communicate with external systems and devices. For example, the external systems unit 36 may include a communications element to communicate with the other communication elements 26, 34, a microcontroller to process information, and a standard interface such as a WiFi, Bluetooth, ANT®, USB, or ZigBee interface operable to easily interface with devices such as cellular phones, portable media players, personal digital assistants, navigation devices, personal and portable computing devices, combinations thereof, and the like. Thus, in some embodiments, the external systems unit 36 may be connected with an immobile personal computer and the interface unit 30 and sensor unit 32 may be positioned on a mobile user, as is shown in FIG. 10. In some configurations, the external systems unit 36 may include a mobile phone, a tablet computer, a laptop computer, or other portable computing device that may be transported to the site of an activity to monitor recorded information in real-time. For example, a coach may employ the external systems unit 36 on the sidelines during a game to evaluate the performance of his or her players.

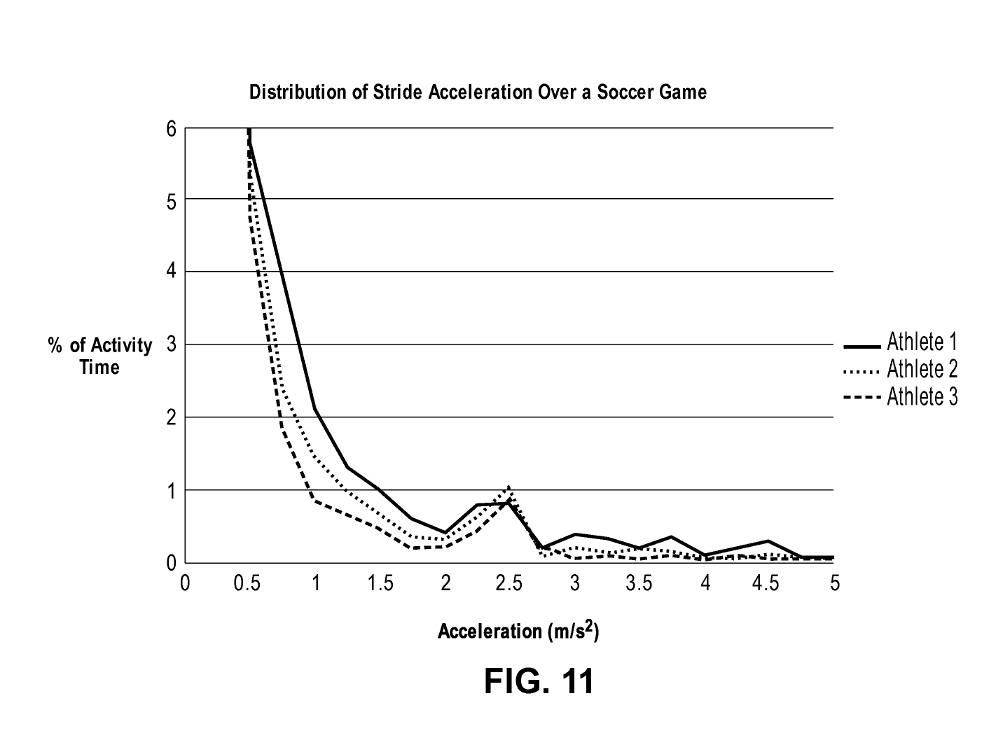

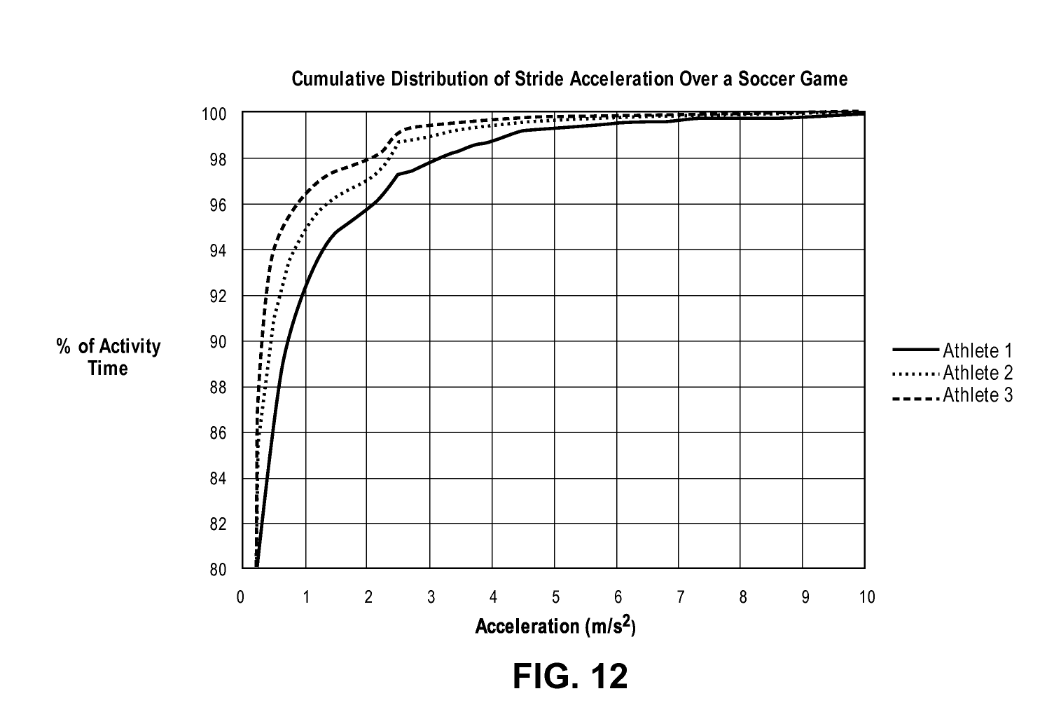

As is shown in FIGS. 6 through 9, the interface unit 30 and sensor unit 32 may each be operable to communicate with the navigation device 24 to receive and utilize navigation information. The navigation device 24 may be discrete from the units 30, 32, as shown in FIG. 6, the navigation device 24 may be integral with the interface unit 30, as shown in FIG. 7, the navigation device 24 may be integral with the sensor unit 32, as shown in FIG. 8, and/or the navigation device 24 may be integral with both units 30, 32, as shown in FIG. 9. Further, in some embodiments, any one or more of the units 30, 32, 36 and navigation device 24 may be automatically disabled when not in use to achieve optimum system power consumption and functionality.

In some embodiments, the sensor unit 32 may be attached to the user's wrist in an enclosure which is similar to a watch and combined with other functionality such as timekeeping or with other sensors such the navigation device 24. In other embodiments, the sensor unit 32 may be attached to the user's arm using an enclosure similar to an armband and combined with other devices such as a cellular phone, an audio device and/or the navigation device 24. In various other embodiments, the sensor unit 32 may be attached to the user with a chest strap in an enclosure which may include other sensors such as a heart-rate monitor (HRM). In yet other embodiments, the sensor unit 32 may be attached to user's waist with, for example, a belt clip. In further embodiments, the sensor unit 32 may be attached to the top of a user's shoe with removable fasteners such as clips. In other embodiments, the sensor unit 32 may be inserted within the user's shoe, such as within a recess formed in the sole of the shoe.

In some embodiments, the sensor unit 32, and/or more generally the apparatus 10, may be operable to attach to more than one portion of the user. For example, the sensor unit 32 may be adapted to attach to any of the various positions discussed above, including but not limited to, the user's wrist, arm, waist, chest, pocket, hat, glove, shoe (internal), and shoe (external). Such a configuration enables the same sensor unit 32, or apparatus 10, to be easily utilized by the user in a variety of positions to generate desirable motion parameters and/or to facilitate ease of use.

The sensor unit 32, and/or more or more of the sensor units 32, may be used to measure acceleration and speed during user movement. For example, in embodiments where the sensor unit 32 is foot mounted, the apparatus 10 can calculate torso speed using the foot acceleration measured by the foot-mounted sensor unit 32.

In some configurations, the sensor unit 32 is configured as a torso-worn sensor to measure the acceleration of the user's core (torso) rather than foot or arm. This configuration can yield a continuous acceleration signal, with potentially higher maximum accelerations recorded than through the use of foot-mounted sensor unit 32.

### Explosiveness

Explosiveness is an important attribute of an athlete's performance during many sports, including such sports as soccer, basketball, tennis, football and others. In this context, explosiveness refers to the ability of an athlete to accelerate rapidly from rest or a relatively lower speed to a higher speed. For example, a soccer player accelerating rapidly to move past a defender to receive a pass, or a basketball player initiating a surprise drive to the basket. In many sports, the performance of the athlete depends on his ability to rapidly initiate or react to instantaneous changes in game direction.

For a typical sprint, acceleration is largest at the beginning of the sprint and declines as the athlete takes subsequent strides. The maximum acceleration achievable by an athlete may be recorded to characterize explosiveness. However, an athlete is required to accelerate rapidly (“explode”) many times during the course of an athletic activity (e.g. soccer game, cycling race, etc.). Consequently, in order to be able to fully characterize an athlete's ability to explode, it is not only useful to quantify one explosive event or instant, but also to quantify the full set (or subset) of such events occurring during the activity.

One or more movement measurements, such as those provided by the sensor unit 32, may be used to quantify explosive events and the number of such events occurring during a sporting activity like soccer, basketball, cycling, running, or the like. In some configurations, acceleration measurements may be provided by the sensor unit 32 to perform an analysis for explosiveness. Additionally or alternatively, the sensor unit 32 may provide speed or position information, acquired through GPS, wheel sensors, cellular signals, or other position-determining methods, to perform the explosiveness analysis.

As explosive motion occurs many times during a game or practice activity, a single metric describing a single explosive event may not be fully adequate to describe or assess an athlete's performance. Both the number of explosive events and their magnitude are useful in order to fully characterize the athlete's performance during the activity. A much more complete characterization of athlete's explosiveness can thus be conveniently captured in a statistical distribution of athlete's acceleration over the activity periods.

The statistical distribution of acceleration can be obtained from a signal representing the athlete's acceleration during the activity period. For example, the acceleration signal can be partitioned into one-second periods, an average acceleration can be computed over each one-second period, and a statistical distribution of these accelerations can be compiled. Analysis of the statistical distribution allows an assessment of an athlete's explosiveness.

Thus, the apparatus 10 may capture the statistical distribution (and thus characterize explosiveness) by recording the instantaneous acceleration (or speed or position) for the entire duration of the activity, and subsequently analyzing this data to compile the statistical distribution of accelerations.

The statistical distribution can be compiled by the sensor unit 32 or other components of the apparatus 10 during the activity and the statistical distribution can then be recorded and presented to the user at the end of the activity. Such a configuration may be useful as it eliminates the need to record the detailed motion signals (position, distance, or acceleration) at a high temporal resolution and therefore limits the amount of system resource (memory) required to store detailed motion signals. Furthermore, subsequent transfer of data from the sensor unit 32 and/or apparatus 10 to an external system is simplified and shortened by reducing the amount of data which needs to be transferred. As recording the timing and magnitude of all motion is memory intensive, the statistical distribution can be compiled by the apparatus 10 during the activity and only the distribution can be recorded and presented to the user at the end of the activity.

In some configurations, the statistical distribution may include or be configured as a histogram such as an acceleration histogram. A histogram, as used herein, is an estimate of a frequency distribution. Histogram may include, but is not limited to, a relative frequency distribution, a kernel density estimation, or any other estimate of a frequency distribution. The data in an acceleration histogram could be used in aggregate to compare the athlete's acceleration distribution during the game or activity with that of the same athlete collected during a previous game, another player or with that of an elite athlete. For example, the breadth or consistency of acceleration values achieved or how much time each of the athletes spends accelerating in excess of some acceleration threshold (e.g. 3 m/s²).

For example, acceleration may be measured continuously or repeatedly by the sensor unit 32 for the duration of an activity. No or low acceleration is indicative of a not very explosive event. High acceleration is indicative of an explosive event. Both explosive and non-explosive events are features of the statistical distribution of the measured accelerations. For example, in a histogram representing stored acceleration measurements, the total area underneath the histogram represents the entire activity. The more of the area that exists in high-acceleration bins (relative to low-acceleration bins), the more “explosive” the user/activity is.

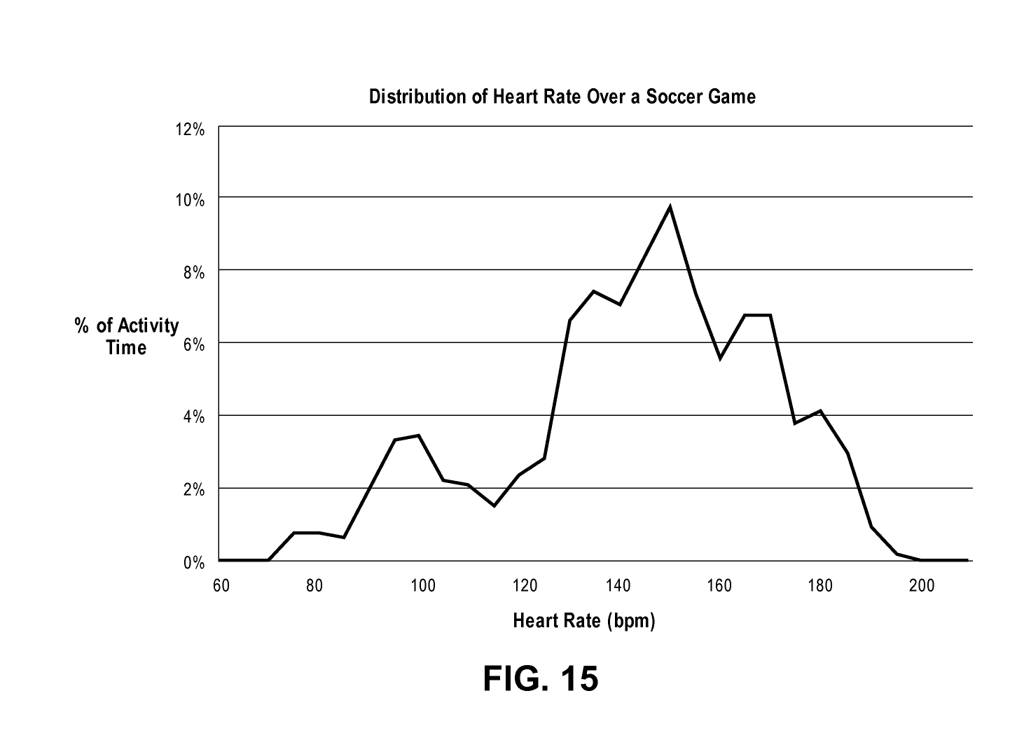

Thus, the statistical distribution could take the form of a histogram binning, for example, the number of strides or the time duration that the athlete achieves in various acceleration ranges. For example, an acceleration bin can include accelerations in the range 1.0-2.9 m/s², 3.0-4.9 m/s², etc. Acceleration bin ranges can be based on, for example, the user, the event, the statistics measured, the amount of memory available on the device, and/or combination thereof. The threshold and/or bin may be defined by an individual or based on the event in which the user is participating. For example, for small children playing soccer, 10 equal-sized bins spanning the range of 0-4m/s2 may be selected, while for professional athletes 15 equal-sized bins spanning the range of 0-10 m/s2 may be selected. Such a statistical distribution can provide the benefit of indicating the performance of the athlete compared to fellow athletes in the same sport. An exemplary histogram is shown in FIG. 11. In FIG. 11, Athlete 1 is more explosive than Athletes 2 and 3, since Athlete 1 tends to spend more time at high accelerations than Athletes 2 and 3.

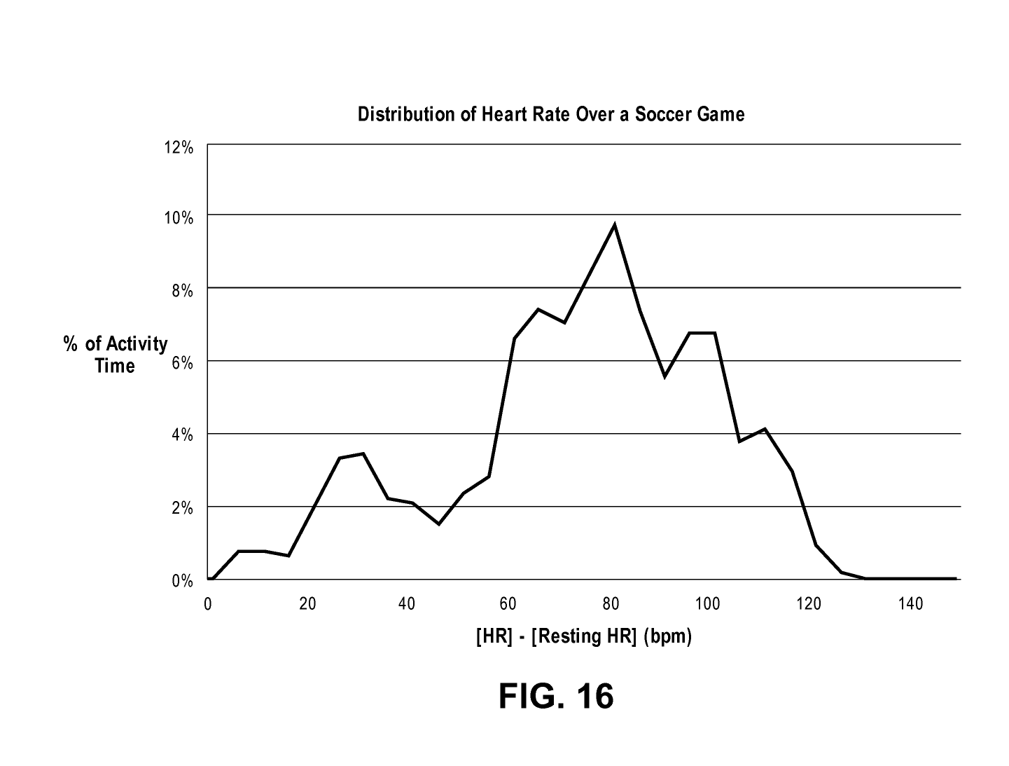

The data of FIG. 11 can also be presented as a cumulative distribution, as shown in FIG. 12. The cumulative distribution in FIG. 12 shows that, for example, Athlete 1 is accelerating at more than 2 m/s² about 4% of game time, while Athlete 3 is accelerating at more than 2 m/s² only around 2% of game time. Conversely, the top 2% of stride accelerations are above 3 m/s² for Athlete 1, while the top 2% of stride accelerations are above 2 m/s² for Athlete 3.

The data in an acceleration histogram could be used in aggregate to compare the athlete's acceleration distribution during the game or activity with that of the same athlete collected during a previous game, another player or with that of an elite athlete. For example, the breadth or consistency of acceleration values achieved or how much time each of the athletes spent in specific acceleration zones could be compared between players.

In addition, single metrics with goals pertinent to the specific sport could be used to evaluate or compare players. These might include such metrics as: What percentage of the session time the athlete exceeded an acceleration? What acceleration values the athlete achieved once or at least x times? What acceleration value the athlete achieved for a percentage of the time?

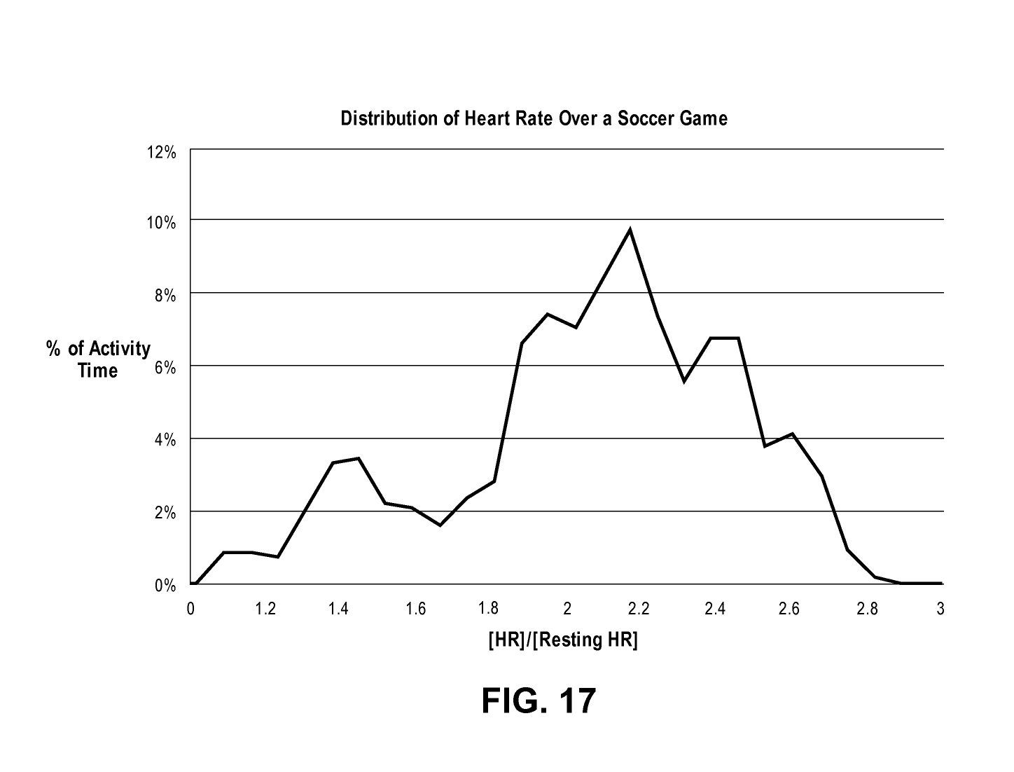

The statistics described in FIGS. 11 and 12 capture the acceleration the athlete achieved for each step. In addition or instead, it may be useful to compute similar statistics which capture acceleration values sustained over multiple strides. For example, a statistic capturing acceleration achieved over 8 consecutive strides might be relevant for a 100 m sprinter or soccer player. On the other hand, a statistic capturing acceleration achieved over 2 consecutive strides might be more relevant in basketball or tennis where the distances are far shorter and 2-step explosiveness is critical. This is illustrated in FIG. 13.

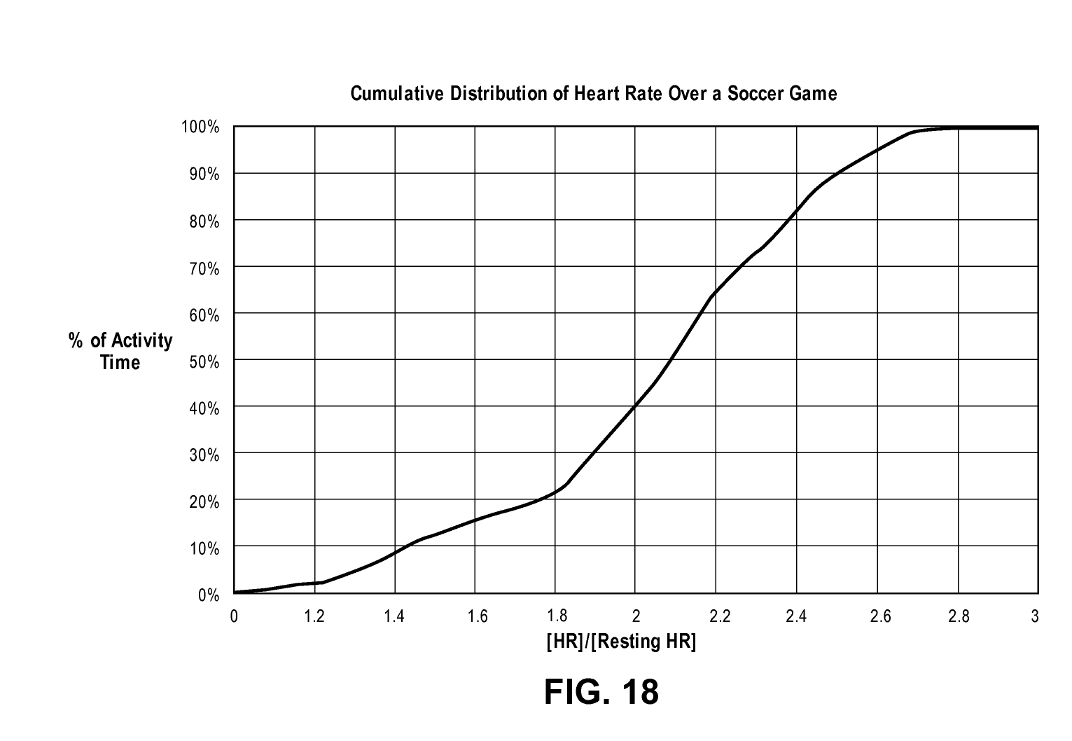

The example statistics of FIGS. 11 through FIGS. 13 summarize all, or at least most, acceleration data collected during the event. In order to further focus on athlete's explosiveness, it may be desirable to, additionally or alternatively, collect statistics only for events which are deemed to be “explosive”. For example, sudden accelerations from stop or a low speed can be considered an “explosive event”, while standing or walking would not be considered “explosive”. FIG. 14 compares statistics collected using all data to statistics collected only using “explosive” data (series “2-Stride Start). In FIG. 14, an “explosive event” is defined as the first 2 strides where the speed at the end of the 2nd stride exceeds the original speed by a factor of 1.5, or if the original speed is 0 m/s.

While the above data describes statistics accumulated over a full activity (e.g. a soccer game), it may be desirable to, in addition or instead, accumulate statistics over a smaller time period. For example in a soccer game, statistic periods may be the individual game halves. For a particular soccer player, comparison of first and second half statistics would provide insight into the player's endurance. The number of explosive events of the user can be organized by quarter. Such a statistical distribution can provide the benefit of indicating a user's stamina by making apparent any change in the frequency and/or magnitude of explosive events of the user over the duration of the football game. A significant decrease in the number of explosive events over a specified threshold can indicate that a user should increase her endurance training so she will be able to perform at a higher level over the entire duration of the event. Alternatively, a coach may analyze player statistics at the end of each game period during a game, and choose to use a different player for the next period if the statistics indicate excessive exhaustion.

Data captured in an acceleration (or other) histogram could also be useful in analyzing individual efforts lasting a few seconds within a much longer session (ex. a game). In a soccer game this could be a sprint halfway down a soccer field on a breakaway. In the absence of instantaneous acceleration info, a runner or coach could see the distribution of accelerations over a prescribed distance, time duration or number of strides to determine how well the runner is ‘shifting gears’ to attain speed efficiently.

For another example, the drive phase is the initial 30 m stage of a 100 m sprint that brings the runner close to their maximum speed. About 7-8 strides into the drive phase (approx 10 m), an elite sprinter strives to attain 70% of his maximum velocity. Over the remaining 7-8 strides (or ˜20 m), the runner should reach 90% of his max velocity, then transition into the stride phase (30-60 m) by the end of which they should be very close to their max speed, before finally moving to the lift phase (60 m+). In addition or as an alternate to the acceleration statistics discussed above, similar statistics can be accumulated and analyzed for athlete's deceleration.

The histogram functionality described above could be used with other metrics to evaluate an athlete's performance, describe a specific training session, or quantify a metric across an over-all season or training program. Histograms could be based on percent of session time, % of distance covered, or similar bins, and could provide distributions of other metrics.

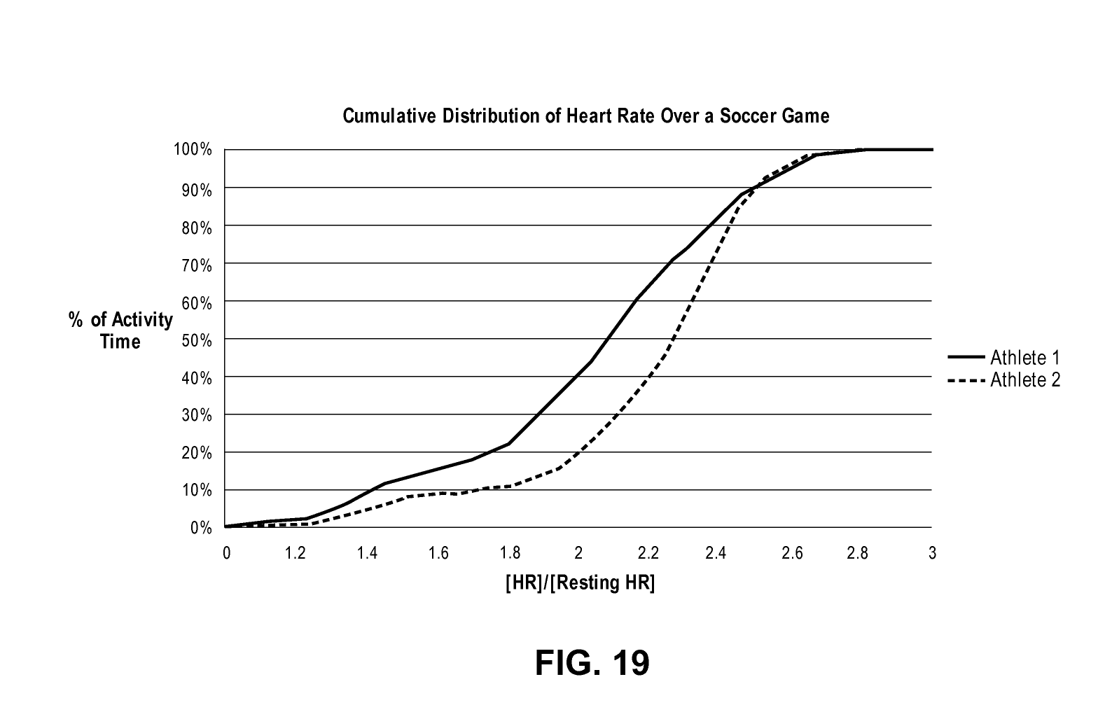

In one example, a heart rate histogram may be generated to show effort applied during the recorded activity. FIGS. 15 through FIGS. 19 illustrate exemplary heart rate histograms. A statistical distribution of heart rate during an event similar to one presented in FIG. 15 can be used by an athlete to compare effort to other events. For a given athlete, heart rate increases with effort and consequently, the larger portion of the activity that an athlete spends at a higher heart rate, the more effort the athlete is expending during the activity.

In order to be able to compare effort between different athletes or for the same athlete over a long period of time, it may be desirable to normalize heart rate statistics before interpretation. For example, heart rate statistics for a particular athlete may be displayed relative to the athlete's heart rate during some specific activity (e.g. resting heart rate, heart rate during a walk at some specific speed). FIGS. 16 and 17 display statistics of FIG. 15 normalized to a resting heart rate of 69 bpm.

An athlete, or a coach, may want to ensure that during a training activity the athlete spends at least, for example, 50% of time at twice the resting heart rate. If not, the training event may need to be adjusted to so that the athlete continues to receive maximum benefit from the activity. In FIG. 18, the athlete spent 60% of activity time above two times the resting heart rate. The coach may also want to compare the effort an athlete put into an athletic event to the effort of another athlete.

FIG. 19 compares the normalized heart rate (method 2) of two athletes. Generally, athlete 2 has a higher HR during most of the game, suggesting that athlete 2 is experiencing more physical exertion during the game. As described herein, the heart rates, explosiveness, and other fitness and movement metrics may be wirelessly exchanged during or after a sporting event to enable the athletes, coaches, and/or spectators to evaluate the performance of the athletes.

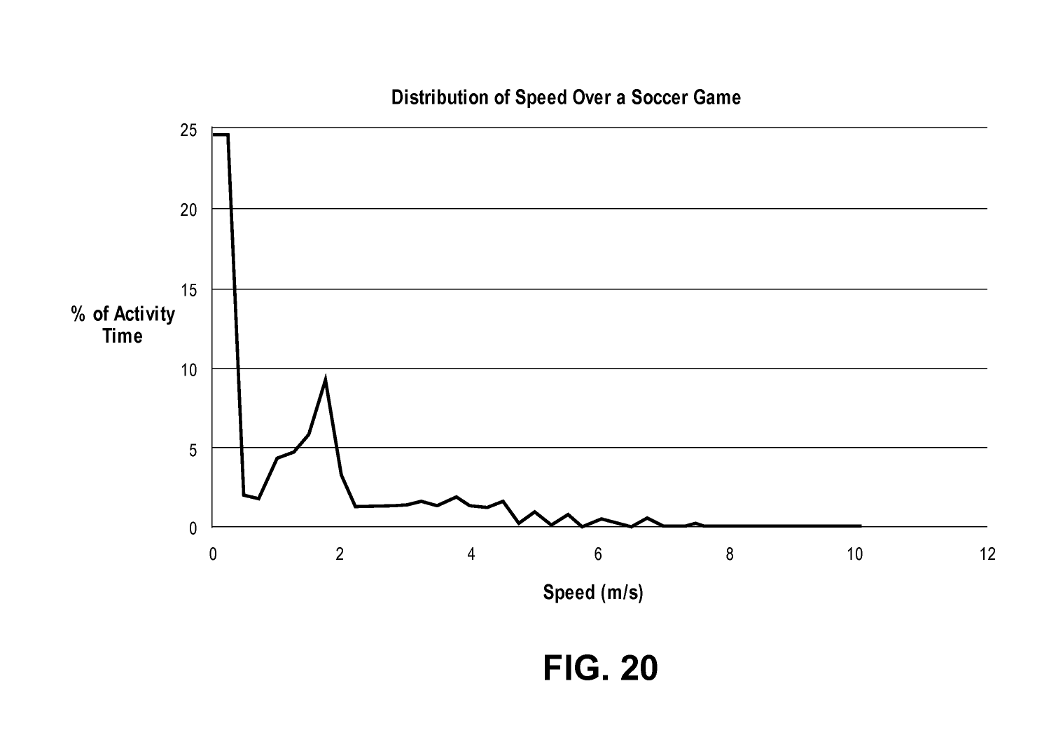

In addition to, or as an alternate to, the histograms described previously, a speed histogram may be created to show the athlete's speed distribution during the activity. This histogram would show how much of time the athlete was walking, jogging, running, or sprinting. FIG. 20 illustrates an example speed histogram to show that during the soccer game, the athlete spent most of the time standing and walking. The athlete also reached speeds up to just under 7 m/s. A cumulative speed distribution based on the above distribution could also be used to represent the player's game effort.

Cadence histograms may also be computed. A cadence histogram shows the motion cadence distribution of the athlete during the activity. Cadence is an attribute of many athletic activities, including, for example, running, cycling and rowing. In many activities changes in cadence reflect the athlete's fatigue level. For example, in cycling, athletes need to increase cadence to reduce the amount of force needed to be applied to the pedals. Cadence is also a metric watched by runners, as many runners believe that increasing cadence while keeping speed constant increases efficiency.

Power output histograms may also be computed. A power output histogram shows the statistical distribution of athlete's power output during an activity. Of course, embodiments of the present invention may employ histograms that represent any type of fitness, movement, exercise, or performance metric.

Utilization of histograms (e.g., statistical distributions) provides an effective tool for characterizing explosiveness. For instance, creating and using histograms condenses an arbitrarily long activity session, like a soccer game, into a fixed-size table. The table size can be an order of magnitude smaller than that required for storing detailed acceleration data for even relatively short activities. That is, use of histograms reduces the processing and memory resources that must be provided by the apparatus 10.

Use of histograms also provides an accurate and quality representation of the level of explosiveness by exploiting averaging which is implicit in statistical distributions. As a result, embodiments of the present invention provide a more powerful way to analyze athletic performance than by analyzing motion data as a function of time. The approach shifts the focus from instantaneous athletic performance (e.g., current acceleration) to athletic performance over an entire event, which is more representative of athlete's ability. The histogram can provide a wealth of information not only to those who have sufficient background to understand the distribution as a whole, but also to others who are only interested in very concise metrics such as single values by extracting those metrics from the from the distribution prior to presentation (e.g. 90%-tile acceleration).

Embodiments of the present invention thus enable the accurate characterization of an explosiveness metric by using histograms such as acceleration histograms. The acceleration histograms may employ variable sample durations to focus on aspects of athletic performance particularly relevant to a given sport (i.e. 1, 2, 4 stride acceleration or 1, 2, 5 second acceleration). Acceleration histograms with variable sample durations to may be used to analyze athletic performance to improve training protocols (i.e. if an athlete has a very good 1-stride performance but poor 4-stride performance, the athlete should improve his/her endurance). Likewise, speed, heart rate, power, and cadence histograms may be used to assess player performance instead of focusing only on instantaneous metrics (e.g., max speed or acceleration).

The histograms, and the resulting characterization of explosiveness, may be accumulated and presented in real-time for immediate use by the monitored athlete, his or her coach, interested spectators, and others. For example, a display of the full histogram, condensed portions of the histogram, or explosiveness information represented by the histogram, may be presented to the monitored athlete by the user interface unit 30 so that the athlete may modify his or her performance in real-time.

Likewise, the athlete may review his or performance, and associated explosiveness, on the user interface unit 30 after competition of the activity. In some configurations, the user interface unit 30 may display a counter of explosive events for review by the athlete. Additionally or alternatively, the number of explosive events may be presented over a given time period, such as a quarter or half of a sporting event, and trend information may be displayed indicating a recent decrease or increase in the number of recorded explosive events. Similarly, the total percent of activity time that is explosive may be presented to the user to indicate explosiveness.

Information sensed by the sensor unit 32, the calculated histogram(s), and/or characterizations of explosiveness may additionally or alternatively be transmitted to the external systems unit 36 for review by the athlete, coaches, and/or spectators in real-time or subsequent to the activity. For example, a soccer coach may monitor the explosivenesses of his players (his team) in real-time to determine when a player is fatigued and should be substituted. Subsequent to the game, the coach may analyze the histograms and associated explosiveness information to determine which players are subject to fatigue and require additional training. Utilization of explosiveness for this analysis, as opposed to simple maximum speed or acceleration, provides a more accurate representation of the player's fitness ability.

The histograms and associated indications of explosiveness may be compared with previously-computed and stored histograms and explosive events. For example, historical distributions can include a previous football game, tennis match, baseball game, and the like, in which the user participated. In various embodiments, the historical statistical distributions can include statistical distributions of other users that have participated in the same event.

It is believed that embodiments of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A system for indicating motion explosiveness for a user, the system comprising:
a display;
an inertial sensor operable to couple with the user to generate signals corresponding to user motion; and
a processing system in communication with the inertial sensor and the display, the processing system operable to—
calculate a histogram representing the sensed user motion, the histogram providing an indication of motion explosiveness, and
communicate with the display to present the indication of motion explosiveness on the display.

2. The system of claim 1, wherein the sensed user motion is acceleration and the histogram represents a statistical distribution of user motion over a period of time.

3. The system of claim 1, wherein the sensed user motion is heart rate and the histogram represents a statistical distribution of user heart rate over a period of time.

4. The system of claim 1, wherein the sensed user motion is speed and the histogram represents a statistical distribution of speed over a period of time.

5. The system of claim 1, further including a communications element coupled with the processing system, the communications element operable to wirelessly transmit information from the processing system to the display.

6. The system of claim 1, wherein the display is remote from the processing system.

7. The system of claim 1, wherein the processing system calculates the histogram in real-time.

8. The system of claim 1, wherein the processing system is operable to select a variable sample duration for the histogram.

9. The system of claim 1, wherein the histogram includes bins and indicates explosiveness based on the distribution of sensed user motion within the bins.

10. The system of claim 1, wherein the indication of motion explosiveness represents the percentage of activity time the user is engaged in explosive events.

11. The system of claim 1, wherein the indication of motion explosiveness represents a number of explosive events during an activity for the user.

12. A system for indicating motion explosiveness for a user, the system comprising:
a display;
an inertial sensor operable to couple with the user to generate signals corresponding to user motion; and
a processing system in communication with the inertial sensor and the display, the processing system operable to—
calculate a histogram in real-time representing the sensed user motion, where the histogram includes bins and indicates user explosiveness based on the distribution of sensed user motion within the bins, and
communicate with the display to present the indication of motion explosiveness on the display, the presented indication of motion explosiveness including the percentage of activity time the user is engaged in explosive events.

13. The system of claim 12, wherein the sensed user motion is acceleration and the histogram represents a statistical distribution of user motion over a period of time.

14. The system of claim 12, wherein the sensed user motion is heart rate and the histogram represents a statistical distribution of user heart rate over a period of time.

15. The system of claim 12, wherein the sensed user motion is speed and the histogram represents a statistical distribution of speed over a period of time.

16. The system of claim 12, further including a communications element coupled with the processing system, the communications element operable to wirelessly transmit information from the processing system to the display.

17. The system of claim 12, wherein the display is remote from the processing system.

18. The system of claim 12, wherein the processing system is operable to select a variable sample duration for the histogram.

19. The system of claim 12, wherein the indication of motion explosiveness includes a number of explosive events during an activity for the user.
